(19) United States
(12) Patent Application Publication
(10) Pub. No.: US 2025/0303772 A1
(43) Pub. Date: Oct. 2, 2025

(54) Method For Producing Transfer Medium

(71) Applicant: SEIKO EPSON CORPORATION, Tokyo (JP)

(72) Inventors: Haruka SATO, Shiojiri (JP); Takayoshi KAGATA, Shiojiri (JP)

(21) Appl. No.: 19/092,233

(22) Filed: Mar. 27, 2025

(30) Foreign Application Priority Data
Mar. 28, 2024 (JP) 2024-053371

(51) Int. Cl. B41M 5/025; B41J 2/005; B41J 2/01; C09D 11/322; C09D 11/54

(52) U.S. Cl. CPC B41M 5/0256; B41J 2/0057; C09D 11/322; C09D 11/54; B41J 2002/012

(57) ABSTRACT

Provided is a method for producing a transfer medium, the method including ejecting a color ink by an ink jet method to form a first layer on a transfer medium having a release layer, ejecting a base ink by an ink jet method to form a second layer so as to be overlaid on the first layer, and ejecting an adhesive ink by an ink jet method to form a third layer so as to be overlaid on the second layer. The adhesive ink contains a resin and water. The base ink contains a base pigment, a resin, and water. An adhesion amount C of the adhesive ink is equal to or larger than an adhesion amount A of the color ink. An adhesion amount B of the base ink is equal to or larger than the adhesion amount A of the color ink. A total adhesion amount of the color ink, the base ink, and the adhesive ink is 230 g/m² or less.

The present application is based on, and claims priority from JP Application Serial Number 2024-053371, filed Mar. 28, 2024, the disclosure of which is hereby incorporated by reference herein in its entirety.

### BACKGROUND

### 1. Technical Field

The present disclosure relates to a method for producing a transfer medium.

### 2. Related Art

A transfer printing method is known in which a transfer sheet, which is a transfer medium on which an image is formed, is overlaid on a transfer target medium such as fabric, and they are heated and pressurized to transfer the image to the transfer target medium. In such a method, an ink jet method is often used because, when the image is formed on the transfer sheet, it is advantageous for forming a fine image in a highly on-demand manner.

In the transfer printing method as described above, generally, an image is formed on a transfer sheet in which a release layer and a hot-melt layer are formed on the entire base material, and then the transfer sheet is heated and pressurized on the transfer target medium to transfer the image.

JP-A-2012-250504 discloses, for the purpose of improving the production speed of the transfer medium, an apparatus for producing a transfer medium, the apparatus including a base nozzle row in which a plurality of nozzles ejecting a base ink are arranged in a predetermined direction, an adhesive nozzle row in which a plurality of nozzles ejecting an adhesive liquid are arranged in the predetermined direction, and a carriage for moving the base nozzle row and the adhesive nozzle row in a moving direction. While the carriage is moved, the base ink is ejected from the nozzles of the base nozzle raw, and the adhesive liquid is ejected from the nozzles at positions aligned with the nozzles ejecting the base ink in the moving direction, thereby producing a transfer medium on which the base ink and the adhesive liquid are applied.

JP-A-2012-250504 aims to improve the production speed by applying the base ink and the adhesive liquid in the same pass. However, depending on the amount of ink applied at a time, the amount of ink may exceed the amount of ink that can be received by the transfer medium, and blurring or the like may occur.

### SUMMARY

A method for producing a transfer medium according to an aspect of the present disclosure includes ejecting a color ink by an ink jet method to form a first layer on a transfer medium having a release layer, ejecting a base ink by an ink jet method to form a second layer so as to be overlaid on the first layer, and ejecting an adhesive ink by an ink jet method to form a third layer so as to be overlaid on the second layer. The adhesive ink contains a resin and water. The base ink contains a base pigment, a resin, and water. An adhesion amount C of the adhesive ink is equal to or larger than an adhesion amount A of the color ink. An adhesion amount B of the base ink is equal to or larger than the adhesion amount A of the color ink. A total adhesion amount of the color ink, the base ink, and the adhesive ink is 230 g/m² or less.

### BRIEF DESCRIPTION OF THE DRAWINGS

FIG. 1A is a schematic sectional view showing a state in which a first layer (a colored layer), a second layer (a base layer), and a third layer (an adhesive layer) are formed on a transfer medium.

FIG. 1B is a schematic view showing a transfer step of transferring the first layer, the second layer, and the third layer from the transfer medium to a transfer target medium.

FIG. 2 is a table showing the compositions of inks.

FIG. 3 is a table showing the evaluation results of Examples and Comparative Examples.

### DESCRIPTION OF EMBODIMENTS

An embodiment of the present disclosure (hereinafter, referred to as “the present embodiment”) will be described below in detail with reference to the drawings as needed, but the present disclosure is not limited thereto, and various modifications can be made without departing from the gist thereof. Note that in the drawings, the same elements are denoted by the same reference signs, and redundant descriptions will be omitted. In addition, positional relationships such as up, down, left, and right are based on the positional relationships shown in the drawings unless otherwise specified. Furthermore, the dimensional ratios in the drawings are not limited to the ratios shown in the drawings.

In the present embodiment, “transfer medium” means a medium as a transfer source for transfer of an image to a transfer target medium. “Transfer target medium” means a medium as a transfer destination to which an image recorded on a transfer medium is transferred. “Transfer object” means a transfer target medium to which an image recorded on a transfer medium has been transferred.

### 1. Method for Producing Transfer Medium

A method for producing a transfer medium of the present embodiment includes a first layer forming step of ejecting a color ink by an ink jet method to form a first layer on a transfer medium having a release layer, a second layer forming step of ejecting a base ink by an ink jet method to form a second layer so as to be overlaid on the first layer, and a third layer forming step of ejecting an adhesive ink by an ink jet method to form a third layer so as to be overlaid on the second layer. The adhesive ink contains a resin and water. The base ink contains a base pigment, a resin, and water. An adhesion amount C of the adhesive ink is equal to or larger than an adhesion amount A of the color ink. An adhesion amount B of the base ink is equal to or larger than the adhesion amount A of the color ink. A total adhesion amount of the color ink, the base ink, and the adhesive ink is 230 g/m² or less.

In a method for producing a transfer medium, many kinds of inks such as a color ink, a base ink, and an adhesive ink are caused to adhere to the transfer medium in an overlaid manner. Thus, from the viewpoint of productivity improvement, it is required to cause these many kinds of inks to adhere in a shorter time. However, when the total amount of ink to be caused to adhere at a time is too large, it is assumed that the amount of ink exceeds the amount of ink that can be received by the transfer medium. In that case, image quality may deteriorate due to, for example, the occurrence of blurring in the image of the transfer object to be obtained.

On the other hand, from the viewpoint of productivity improvement and image quality maintenance, the adhesion amount of each ink may be simply reduced. However, if the adhesion amount of the adhesive ink is reduced in particular, a decrease in transferability is caused, and there is also concern about a decrease in the rubbing fastness of the transfer object to be obtained.

Thus, in the method for producing a transfer medium of the present embodiment, the magnitude relationship of the adhesion amounts of the various inks and the total adhesion amount thereof are specified together with the compositions of the various inks. This can produce a transfer object having excellent image quality and having further improved transferability, dry rubbing fastness, and wet rubbing fastness.

### 1.1. First Layer Forming Step

The first layer forming step is a step of ejecting a color ink by an ink jet method to form a first layer on a transfer medium having a release layer.

The adhesion amount A of the color ink is preferably 5.0 to 50 g/m², 7.5 to 40 g/m², 10 to 30 g/m², or 15 to 25 g/m².

“Ink jet method” refers to a method of driving a pressure generating unit provided in an ink jet head to eject, from a nozzle, an ink composition charged in a pressure generating chamber of the ink jet head. Examples of the ink jet method include a charge deflection method, a continuous method, and an on-demand system such as a piezoelectric method or a bubble jet (registered trademark) method, depending on the pressure generating unit. Among these, the piezoelectric method is preferred from the viewpoint of the resistance of the ink composition to deterioration and the viewpoint of ejection stability.

Examples of the ink jet head used in the ink jet method include a line head that performs recording by a line system and a serial head that performs recording by a serial system.

In the line system using the line head, for example, an ink jet head having a width equal to or larger than the recording width of the transfer medium is fixed to a recording apparatus. The transfer medium is moved along a sub-scanning direction (the transport direction of the transfer medium), and ink droplets are ejected from nozzles of the line head in conjunction with this movement, thereby forming the first layer on the transfer medium.

In the serial system using the serial head, for example, an ink jet head is mounted on a carriage movable in the width direction of the transfer medium. The carriage is moved along a main scanning direction (the width direction of the transfer medium), and ink droplets are ejected from nozzles of the serial head in conjunction with this movement, thereby forming the first layer on the transfer medium.

Note that the first layer has been described above as an example, and the same applies to the second layer and the third layer, which will be described below.

### 1.1.1. Transfer Medium

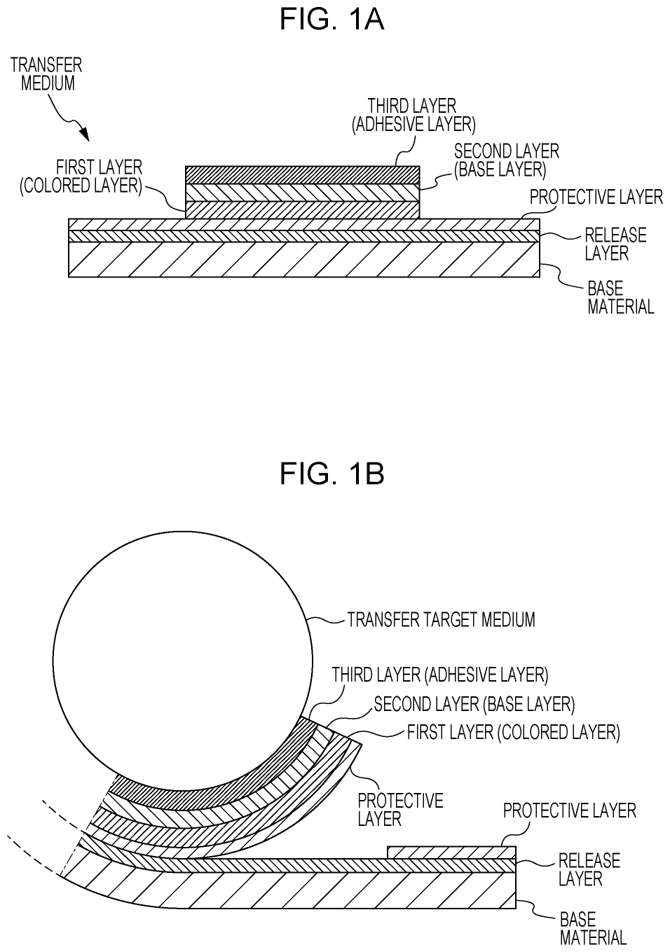

FIG. 1A is a schematic sectional view showing a state in which the first layer (the colored layer), the second layer (the base layer), and the third layer (the adhesive layer) are formed on the transfer medium. As shown in FIG. 1A, the transfer medium is not particularly limited so long as it has the release layer, and may have the release layer on a base material and may further have a protective layer on the release layer. The transfer medium may have a sheet-like or film-like shape.

The base material is not particularly limited so long as it is a support for supporting the release layer. Such a base material is not particularly limited, and examples thereof include resin films such as those of polyesters such as polyethylene terephthalate and polyolefins such as polyethylene and polypropylene, as well as metals, wood, and paper.

The release layer is a layer for enhancing transferability from the transfer medium to the transfer target medium. The release layer may be a layer containing a known release agent. The release agent is not particularly limited, and examples thereof include polyethylene wax-based release agents, silicone-based release agents, and fluorine-based release agents. The thickness of the release layer is, for example, 5 to 80 μm or 10 to 50 μm.

The protective layer is a layer that is released at the interface with the release layer and is transferred to the transfer target medium together with the first layer, the second layer, and the third layer during transfer, and is a layer for enhancing the abrasion resistance of the first layer and the second layer transferred to the transfer target medium.

When the protective layer is not present, the first layer, the second layer, and the third layer are formed on the release layer, and during transfer, the first layer is released at the interface with the release layer, and the first layer, the second layer, and the third layer are transferred to the transfer target medium.

The first layer (the colored layer) is formed by causing a color ink to adhere to the transfer medium. The colored layer in the figure is formed on the upper side of the protective layer (the upper side of the base material) on the transfer medium, but may be formed on the release layer when the protective layer is not present.

The second layer (the base layer) is a layer serving as a base for the first layer (the colored layer) to be transferred to the transfer target medium. The base layer is formed on the upper side of the colored layer on the transfer medium so as to be positioned between the adhesive layer and the colored layer during transfer.

The third layer (the adhesive layer) is a layer for causing the colored layer and the like to adhere to the transfer target medium. The adhesive layer is formed on the upper side of the base layer on the transfer medium so as to be positioned between the transfer target medium and both the base layer and the colored layer during transfer.

### 1.1.2. Color Ink

The color ink may contain a pigment, a resin, a water-soluble organic solvent, a surfactant, and water. The color ink may include a plurality of kinds of inks having different color tones, such as a cyan ink, a magenta ink, a yellow ink, and a black ink.

### 1.1.2.1. Pigment

Examples of the pigment include organic pigments such as azo pigments (e.g., azo lakes, insoluble azo pigments, condensed azo pigments, chelate azo pigments, and the like), polycyclic pigments (e.g., phthalocyanine pigments, perylene pigments, perinone pigments, anthraquinone pigments, quinacridone pigments, dioxazine pigments, thioindigo pigments, isoindolinone pigments, quinophthalone pigments, and the like), nitro pigments, nitroso pigments, and aniline black; inorganic pigments such as carbon blacks (e.g., furnace black, thermal lamp black, acetylene black, channel black, and the like), metal oxides, metal sulfides, and metal chlorides; and extender pigments such as calcium carbonate and talc.

The pigment may be added to the ink as a pigment dispersion liquid obtained by dispersing the pigment in water with a dispersant, as a pigment dispersion liquid obtained by dispersing in water a self-dispersed surface-treated pigment (hereinafter also referred to as “self-dispersed pigment”) in which a hydrophilic group is introduced onto pigment particle surfaces using a chemical reaction, or as a pigment dispersion liquid obtained by dispersing in water a pigment coated with a polymer (hereinafter also referred to as “resin-dispersed pigment”).

The content of the pigment is preferably 1.0 to 10% by mass, 2.0 to 8.0% by mass, or 3.0 to 7.0% by mass with respect to the total mass of the color ink.

### 1.1.2.2. Resin

When the color ink contains resin particles, the abrasion resistance of a coating film to be obtained tends to further improve. The resin may be in a dispersed state such as a resin emulsion or resin particles or may be in a dissolved state such as a water-soluble resin. One type of resin may be used alone, or two or more types may be used in combination.

Examples of the resin include resins such as urethane-based resin, acrylic-based resins (including styrene-acrylic-based resins), fluorene-based resins, polyolefin-based resins, rosin-modified resins, terpene-based resins, polyester-based resins, polyamide-based resins, epoxy-based resins, and vinyl chloride-based resins.

The urethane-based resin is not particularly limited, and examples thereof include urethane resin emulsions. The urethane resin emulsion is not particularly limited so long as it is a resin emulsion having a urethane bond in the molecule, and examples thereof include polyether type urethane resins containing an ether bond in the main chain, polyester type urethane resins containing an ester bond in the main chain, and polycarbonate type urethane resins containing a carbonate bond in the main chain. Among these, cationic or anionic urethane resin fine particles are preferred.

The acrylic-based resin is not particularly limited, and examples thereof include resins obtained by polymerizing a (meth)acrylic monomer such as (meth)acrylic acid or a (meth)acrylic acid ester and acrylic resin emulsions obtained by copolymerizing a (meth)acrylic monomer and another monomer.

The content (solid content) of the resin is preferably 2.0 to 15% by mass, 3.0 to 10% by mass, or 4.0 to 8.0% by mass with respect to the total mass of the color ink. This can make the ejection stability of the color ink by the ink jet method, the production stability of the transfer object, and the texture of the transfer object sufficiently excellent and, in addition, make the dispersion stability of the pigment in the color ink more excellent.

### 1.1.2.3. Water-Soluble Organic Solvent

The water-soluble organic solvent is not particularly limited, and examples thereof include polyol compounds, glycol ethers, and cyclic amide compounds. One type of water-soluble organic solvent may be used alone, or two or more types may be used in combination.

In the present embodiment, the water-soluble organic solvent refers to an organic solvent having a solubility in water at 25° C. of 10 g/100 g of water or more.

Examples of the polyol compound include polyol compounds, preferably diol compounds, having two or more and six or less carbon atoms in the molecule and optionally having one ether bond in the molecule. Specific examples thereof include glycols such as 1,2-pentanediol, glycerin, ethylene glycol, diethylene glycol, triethylene glycol, polyethylene glycol, propylene glycol, dipropylene glycol, tripropylene glycol, polypropylene glycol, polyoxyethylene polyoxypropylene glycol, 1,2-hexanediol, 1,2-heptanediol, 1,3-propanediol, 1,2-butanediol, 1,3-butanediol, 1,4-butanediol, 2,3-butanediol, 2-methyl-3-phenoxy-1,2-propanediol, 3-(3-methylphenoxy)-1,2-propanediol, 3-hexyloxy-1,2-propanediol, 2-hydroxymethyl-2-phenoxymethyl-1,3-propanediol, 3-methyl-1,3-butanediol, 1,5-pentanediol, 1,6-hexanediol, 2-methyl-2,4-pentanediol, and 3-methyl-1,5-pentanediol.

Examples of the glycol ether include monoalkyl ethers of glycols selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. Examples of the monoalkyl ether include triethylene glycol monomethyl ether, triethylene glycol monobutyl ether, triethylene glycol monoethyl ether, and dipropylene glycol monopropyl ether.

Examples of the cyclic amide compound include 2-pyrrolidone, N-methyl-2-pyrrolidone, N-hydroxyethyl-2-pyrrolidone, 1,3-dimethylimidazolidinone, 2-piperidone (δ-valerolactam), and N-cyclohexyl-2-pyrrolidone.

The content of the water-soluble organic solvent is preferably 5 to 35% by mass, 10 to 30% by mass, or 15 to 25% by mass with respect to the total mass of the color ink. This makes it possible to more suitably adjust the viscosity and surface tension of the color ink. In addition, the moisture retention of the color ink is more excellent, the solid content of the color ink is more effectively prevented from, for example, being undesirably precipitated due to drying or the like in the ink jet head or the like, clogging recoverability can be made more excellent, and the ejection stability of the color ink can be made more excellent.

### 1.1.2.4. Surfactant

The ink composition may contain a surfactant. Examples of the surfactant include acetylene glycol-based surfactants, silicone-based surfactants, and fluorine-based surfactants. One type of surfactant may be used alone, or two or more types may be used in combination.

The acetylene glycol-based surfactant is not particularly limited, and examples thereof include alkylene oxide adducts of 2,4,7,9-tetramethyl-5-decyne-4,7-diol and 2,4,7,9-tetramethyl-5-decyne-4,7-diol and alkylene oxide adducts of 2,4-dimethyl-5-decyn-4-ol and 2,4-dimethyl-5-decyn-4-ol.

The silicone-based surfactant is not particularly limited, and examples thereof include polysiloxane-based compounds and polyether-modified organosiloxanes.

The fluorine-based surfactant is not particularly limited, and examples thereof include perfluoroalkyl sulfonic acid salts, perfluoroalkyl carboxylic acid salts, perfluoroalkyl phosphoric acid esters, perfluoroalkyl ethylene oxide adducts, perfluoroalkyl betaines, and perfluoroalkyl amine oxide compounds.

The content of the surfactant is preferably 0.02 to 1.50% by mass, 0.05 to 1.00% by mass, or 0.10 to 0.70% by mass with respect to the total mass of the color ink. This makes it possible to more suitably adjust the viscosity and surface tension of the color ink.

### 1.1.2.5. Water

The content of water is preferably 50 to 90% by mass, 55 to 85% by mass, or 60 to 80% by mass with respect to the total amount of the color ink. This makes it possible to more suitably adjust the viscosity and surface tension of the color ink.

### 1.1.2.6. Other Components

To maintain good storage stability and ejection stability from the head, to improve clogging recoverability, or to prevent deterioration of the ink composition, various additives such as a dissolution aid, a viscosity modifier, a pH adjuster, an antioxidant, a preservative, a fungicide, a corrosion inhibitor, and a chelating agent for capturing metal ions that affect dispersion may be added to the color ink as appropriate.

### 1.2. Second Layer Forming Step

The second layer forming step is a step of ejecting a base ink by an ink jet method to form a second layer so as to be overlaid on the first layer. In the second layer forming step, the adhesion amount B of the base ink is set to be equal to or larger than the adhesion amount A of the color ink. This makes the second layer formed of the base ink thicker, and transferability and the rubbing fastness of the transfer object tend to further improve. In addition, since there is no need to cause the adhesive ink in an excessive amount to adhere in view of improving transferability and the rubbing fastness of the transfer object, the total adhesion amount can be reduced. Furthermore, since shielding properties also improve, the color development of the color ink further improves.

The adhesion amount B of the base ink is preferably 0.6 g/m² or more, 1.0 to 170 g/m², 5.0 to 160 g/m², 10 to 150 g/m², 15 to 140 g/m², 50 to 130 g/m², or 75 to 130 g/m². When the adhesion amount B of the base ink is 0.6 g/m² or more, there is a tendency that shielding properties further improve, the color development of the color ink further improves, and transferability and the rubbing fastness of the transfer object also further improve. When the adhesion amount B of the base ink is 170 g/m² or less, there is a tendency that blurring or the like is less likely to occur, and image quality further improves.

The ratio (B/A) of the adhesion amount B of the base ink to the adhesion amount A of the color ink is preferably 1.0 to 10, 1.0 to 8.0, 2.0 to 7.0, or 3.0 to 6.0. When the ratio (B/A) is 1.0 or more, there is a tendency that shielding properties further improve, the color development of the color ink further improves, and transferability and the rubbing fastness of the transfer object also further improve. When the ratio (B/A) is 10 or less, there is a tendency that blurring or the like is less likely to occur, and image quality further improves.

In the second layer forming step, there is no particular limitation so long as the second layer is formed so as to be overlaid on the first layer, and the first layer and the second layer may have the same pattern, or the second layer may have a wider pattern. In addition, when the second layer is formed on the first layer, the second layer may be formed before the first layer is dried (also referred to as “wet on wet”), or the second layer may be formed after the first layer is dried (also referred to as “wet on dry”).

### 1.2.1. Base Ink

The base ink contains a base pigment, a resin, and water and may contain a water-soluble organic solvent and a surfactant as needed.

### 1.2.1.1. Base Pigment

Examples of the base pigment include white pigments and metallic pigments.

By using the white pigment, a white base layer can be formed. When the white base layer having light blocking properties is positioned between the transfer target medium and the colored layer after transfer, the visibility of a color image (the colored layer) tends to improve. In addition, when the white base layer having light blocking properties is transferred to the transfer target medium, the color of the transfer target medium itself can be hidden in a portion where the colored layer is not present on the base layer.

By using the metallic pigment, a metallic layer can be formed. When the metallic layer having metallic luster is positioned between the transfer target medium and the colored layer after transfer, the color image (the colored layer) is visually recognized as having metallic luster.

The solid content of the base pigment is preferably 5.0 to 15% by mass or 7.5 to 12.5% by mass with respect to the total amount of the base ink. When the solid content of the base pigment is within the above range, there is a tendency that shielding properties further improve, the color development of the color ink further improves, and transferability, the rubbing fastness of the transfer object, and ejection stability also further improve.

### 1.2.1.2. Resin

Examples of the resin include the same resins as those exemplified for the color ink. The resin of the color ink and the resin of the base ink may be the same or different. In particular, it is preferable that the resin of the color ink and the resin of the base ink be the same when they are resins such as urethane-based resins. In this case, since the first layer and the second layer are formed of the same kind of resin, transferability and the rubbing fastness of the transfer object tend to further improve. Note that the resin does not include hollow resin particles, which constitute ink coating films and may be used as white pigments.

The solid content of the resin contained in the base ink is preferably 5 to 15% by mass or 7.5 to 12.5% by mass with respect to the total amount of the base ink. This makes the ejection stability of the base ink by the ink jet method, the stability of the production of the transfer object, and the texture of the transfer object sufficiently excellent and, in addition, tends to further improve transferability, the rubbing fastness of the transfer object, and ejection stability.

### 1.2.1.3. Water-Soluble Organic Solvent

Examples of the water-soluble organic solvent include the same water-soluble organic solvents as those exemplified for the color ink. The water-soluble organic solvent of the color ink and the water-soluble organic solvent of the base ink may be the same or different.

The content of the water-soluble organic solvent is preferably 5 to 30% by mass, 10 to 25% by mass, or 15 to 20% by mass with respect to the total mass of the base ink. This makes it possible to more suitably adjust the viscosity and surface tension of the base ink. In addition, the moisture retention of the base ink is more excellent, the solid content of the base ink is more effectively prevented from, for example, being undesirably precipitated due to drying or the like in the ink jet head or the like, clogging recoverability can be made more excellent, and the ejection stability of the base ink can be made more excellent.

### 1.2.1.4. Surfactant

Examples of the surfactant include the same surfactants as those exemplified for the color ink. The surfactant of the color ink and the surfactant of the base ink may be the same or different.

The content of the surfactant is preferably 0.02 to 1.50% by mass, 0.05 to 1.00% by mass, or 0.10 to 0.70% by mass with respect to the total mass of the base ink. This makes it possible to more suitably adjust the viscosity and surface tension of the base ink.

### 1.2.1.5. Water

The content of water is preferably 45 to 80% by mass, and more preferably 50 to 75% by mass, or 55 to 70% by mass, with respect to the total amount of the base ink. This makes it possible to more suitably adjust the viscosity and surface tension of the base ink.

### 1.2.1.6. Other Components

To maintain good storage stability and ejection stability from the head, to improve clogging recoverability, or to prevent deterioration of the ink composition, various additives such as a dissolution aid, a viscosity modifier, a pH adjuster, an antioxidant, a preservative, a fungicide, a corrosion inhibitor, and a chelating agent for capturing metal ions that affect dispersion may be added to the base ink as appropriate.

### 1.3. Third Layer Forming Step

The third layer forming step is a step of ejecting an adhesive ink by an ink jet method to form a third layer so as to be overlaid on the second layer. In the related art, the third layer has been formed by sprinkling an adhesive in the form of powder over the second layer, not by the ink jet method. However, in the method using the powder, a mechanism for sprinkling the powder is required, which increases the size of the apparatus, and in addition, it is necessary to remove excess sprinkled powder, and the texture of the transfer object may be impaired due to the excessive powder. In contrast, in the present embodiment, by forming the third layer by the ink jet method, an increase in the size of the production apparatus is reduced, and, in addition, the texture can be further improved.

In the third layer forming step, the adhesion amount C of the adhesive ink is set to be equal to or larger than the adhesion amount A of the color ink. This allows the first layer to be easily released at the interface with the release layer and thus allows the first layer, the second layer, and the third layer to be easily transferred to the transfer target medium.

The adhesion amount C of the adhesive ink is preferably 20 to 200 g/m², 40 to 180 g/m², or may be 60 to 160 g/m². When the adhesion amount C of the adhesive ink is 20 g/m² or more, releasability tends to further improve. In addition, when the adhesion amount C of the adhesive ink is 200 g/m² or less, blurring tends to be reduced.

The ratio (C/A) of the adhesion amount C of the adhesive ink to the adhesion amount A of the color ink is preferably 1 to 10, 2 to 9, or 3 to 8. When the ratio (C/A) is within the above range, there is a tendency that releasability further improves, and blurring is further inhibited. In addition, the ratio (C/A) may be 1 to 6 or 2 to 5 from the viewpoint of further improving color developing properties. In addition, the ratio (C/A) may be 5 to 10 or 6 to 9 from the viewpoint of further improving releasability.

The ratio (C/B) of the adhesion amount C of the adhesive ink to the adhesion amount B of the base ink is preferably 0.3 to 10 or 0.5 to 8. When the ratio (C/B) is within the above range, there is a tendency that releasability further improves, and blurring is further inhibited. In addition, the ratio (C/B) may be 0.3 to 3, 0.3 to 2, or 0.4 to 1 from the viewpoint of further improving color developing properties. Furthermore, the ratio (C/B) may be 5 to 10, 6 to 9, or 7 to 8 from the viewpoint of further improving releasability.

The total adhesion amount (A+B+C) of the color ink, the base ink, and the adhesive ink is 230 g/m² or less, and preferably 220 g/m² or less, 210 g/m² or less, 200 g/m² or less, or 195 g/m² or less. In addition, the total adhesion amount (A+B+C) of the color ink, the base ink, and the adhesive ink is preferably 150 g/m² or more, 160 g/m² or more, 170 g/m² or more, 180 g/m² or more, or 190 g/m² or more. When the adhesion amount (A+B+C) is 230 g/m² or less, image blurring is inhibited, and rubbing fastness and washing fastness also further improve. On the other hand, when the adhesion amount (A+B+C) is 150 g/m² or more, color developing properties, transferability, and the like tend to further improve.

The ratio ((B+C)/A) of the total adhesion amount (B+C) of the base ink and the adhesive ink to the adhesion amount A of the color ink is preferably 2.0 to 14, 4.0 to 12, or 6.0 to 10. When the ratio ((B+C)/A) is within the above range, transferability, dry rubbing fastness, wet rubbing fastness, washing fastness, and the like tend to further improve.

### 1.3.1. Adhesive Ink

The adhesive ink contains a resin and water and may contain an organic solvent and a surfactant as needed. The resin contained in the adhesive ink mainly contributes to transferability and the rubbing fastness of the transfer object. The adhesive ink preferably does not contain a coloring material such as a pigment. The content of the coloring material in the adhesive ink is preferably 0.5% by mass or less or 0.1% by mass or less.

### 1.3.1.1. Resin

The resin may be in a dispersed state such as a resin emulsion or resin particles or may be in a dissolved state such as a water-soluble resin. One type of resin may be used alone, or two or more types may be used in combination.

The resin contained in the adhesive ink is not particularly limited, and examples thereof include monomers and oligomers generally used in adhesives, such as acrylic-based resins, urethane-based resins, vinyl chloride-based resins, styrene acrylic-based resins, and vinyl acetate-based resins, and resins such as polyester-based resins, polyacrylate-based resins, polyvinyl acetate-based resins, vinyl-based resins such as polyvinyl chloride resins and polyvinyl alcohol resins, polyvinyl acetal-based resins such as polyvinyl acetoacetal and polyvinyl butyral, polyether-based resins, polyethersulfone-based resins, polyurethane-based resins, styrene acrylate-based resins, polyacrylamide-based resins, polyamide-based resins, polystyrene-based resins, polyethylene-based resins, polypropylene-based resins, and polyvinylpyrrolidone-based resins.

The glass transition temperature of the resin contained in the adhesive ink is preferably −20 to 50° C., −10 to 45° C., or 0 to 40° C. When the glass transition temperature is within the above range, transferability, texture, and rubbing fastness and washing fastness can be simultaneously achieved at a higher level.

The melting point of the resin contained in the adhesive ink is preferably 80 to 140° C., 85 to 130° C., or 90 to 120° C. When the melting point is within the above range, transferability, texture, and rubbing fastness and washing fastness can be simultaneously achieved at a higher level.

The solid content of the resin contained in the adhesive ink is preferably 10 to 20% by mass or 7.5 to 12.5% by mass with respect to the total amount of the adhesive ink. This makes the ejection stability of the base ink by the ink jet method, the stability of the production of the transfer object, and the texture of the transfer object sufficiently excellent and, in addition, tends to further improve transferability, the rubbing fastness of the transfer object, and ejection stability.

### 1.3.1.2. Water-Soluble Organic Solvent

Examples of the water-soluble organic solvent include the same water-soluble organic solvents as those exemplified for the color ink. The water-soluble organic solvent of the color ink and the water-soluble organic solvent of the base ink may be the same or different.

The content of the water-soluble organic solvent is preferably 5 to 30% by mass, 10 to 25% by mass, or 15 to 20% by mass with respect to the total mass of the adhesive ink. This makes it possible to more suitably adjust the viscosity and surface tension of the base ink. In addition, the moisture retention of the base ink is more excellent, the solid content of the base ink is more effectively prevented from, for example, being undesirably precipitated due to drying or the like in the ink jet head or the like, clogging recoverability can be made more excellent, and the ejection stability of the base ink can be made more excellent.

### 1.3.1.3. Surfactant

Examples of the surfactant include the same surfactants as those exemplified for the color ink. The surfactant of the color ink and the surfactant of the base ink may be the same or different.

The content of the surfactant is preferably 0.02 to 1.50% by mass, 0.05 to 1.00% by mass, or 0.10 to 0.70% by mass with respect to the total mass of the adhesive ink.

This makes it possible to more suitably adjust the viscosity and surface tension of the adhesive ink.

### 1.3.1.4. Water

The content of water is preferably 55 to 85% by mass, and more preferably 60 to 80% by mass, or 65 to 75% by mass, with respect to the total amount of the adhesive ink. This makes it possible to more suitably adjust the viscosity and surface tension of the adhesive ink.

### 1.4. Transfer Step

FIG. 1B is a schematic view showing a transfer step of transferring the first layer, the second layer, and the third layer from the transfer medium to the transfer target medium. FIG. 1B shows transfer to a transfer target medium having a curved surface, but the transfer target medium is not limited to one having a curved surface and may be one having a flat surface.

In the transfer step, the third layer (the adhesive layer) adheres to a transfer surface of the transfer target medium, and the first layer is released at the interface with the release layer, whereby the first layer, the second layer, and the third layer are transferred to the transfer target medium. On the transfer target medium after transfer, the protective layer, the first layer (the colored layer), the second layer (the base layer), and the third layer (the adhesive layer) are formed (transferred) in this order from the top (the surface side).

By transferring an image in this way, a color image can be easily formed on any surface, whether the transfer surface of the transfer target medium is a curved surface or a flat surface. Thus, transfer can be performed on transfer target media having various shapes, such as the interior of an automobile, the exterior of a notebook computer, the exterior of a mobile phone, a cosmetic container, and stationery.

The transfer target medium is not particularly limited, and examples thereof include various types of paper, porous metals, porous ceramics, porous glasses, porous plastics, fabrics, and leathers.

In the transfer step, transfer to the transfer target medium may be performed after the adhesive force of the third layer (the adhesive layer) positioned on the surface of the transfer medium is improved by heating. The heating temperature in the transfer step is, for example, 120 to 270° C., 140 to 250° C., or 150 to 210° C. The heating time in the transfer step is, for example, 5 to 90 seconds, 15 to 70 seconds, or 20 to 60 seconds. This can improve the adhesive force of the third layer (the adhesive layer) to the transfer target medium and further improve the releasability between the release layer and the first layer. Thus, there is a tendency that the first layer, the second layer, and the third layer can be avoided from remaining on the release layer after transfer.

In the transfer step, transfer to the transfer target medium may be performed after the transfer medium is pressurized against the transfer target medium. The pressure to be applied to the transfer medium and the transfer target medium is, for example, 0.1 to 30 N/cm², 0.6 to 15 N/cm², or 1.5 to 5 N/cm². This tends to improve the adhesive force of the third layer (the adhesive layer) to the transfer target medium. Thus, there is a tendency that the first layer, the second layer, and the third layer can be avoided from remaining on the release layer after transfer.

### EXAMPLES

The present disclosure will be described below in more detail with reference to Examples and Comparative Examples. The present disclosure is not limited by the following Examples in any way. Note that each operation was performed at room temperature (25° C.) unless otherwise specified.

### 1. Ink Preparation

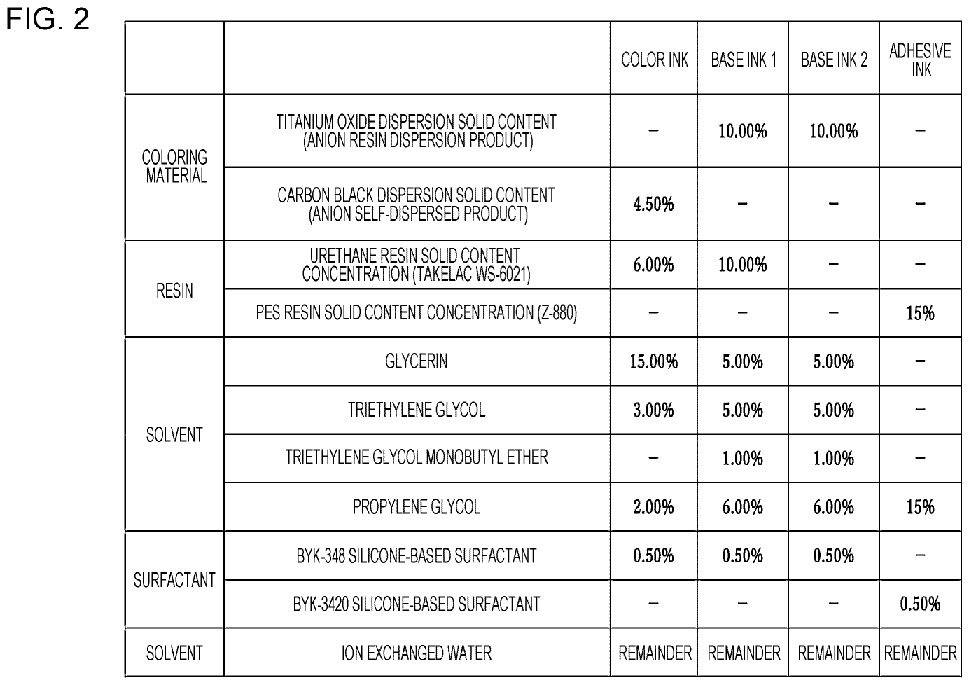

FIG. 2 is a table showing the compositions of inks. Each component was put into a mixture tank so as to have the composition shown in FIG. 2, mixed and stirred, and further filtered through a membrane filter to obtain an ink jet ink composition of each example. The numerical value of each component shown in each example in the table represents % by mass unless otherwise specified. In the table, the numerical value of each pigment represents % by mass of the solid content.

The abbreviations and the details of the product components used in FIG. 2 are as follows.

### Coloring Material

Titanium oxide dispersion solid content (manufactured by C.I. Kasei Co., Ltd., anion resin dispersion product)
Carbon black dispersion solid content (manufactured by Orient Chemical Industries Co., Ltd., anion self-dispersed product)

### Resin

Urethane resin solid content concentration (manufactured by Mitsui Chemicals, Inc., TAKELAC WS-6021)
PES resin solid content concentration (manufactured by Goo Chemical Co., Ltd., Z-880)

### Solvent

Glycerin
Triethylene glycol
Triethylene glycol monobutyl ether
Propylene glycol

### Surfactant

BYK-348 silicone-based surfactant (manufactured by BYK)
BYK-3420 silicone-based surfactant (manufactured by BYK)

### 2. Production of Transfer Medium

A transfer medium (manufactured by Inkmania, a print film for DTF) in which a release layer containing a release agent was provided on a base material made of polyethylene terephthalate was obtained. Next, an ink jet recording apparatus (manufactured by Seiko Epson Corporation, SC F2150) was filled with each ink prepared as described above.

The color ink was then ejected from the ink jet head to the surface of the transfer medium provided with the release layer to form a first layer with a predetermined pattern, then the base ink was ejected from the ink jet head to form a second layer on the first layer, and finally the adhesive ink was ejected from the ink jet head to form a third layer on the second layer. Subsequently, heating was performed at 160° C. for 2.5 minutes to obtain a transfer medium. In Comparative Example 2, instead of forming the third layer, a resin powder of Hot-Melt Powder PU (polyurethane) manufactured by Inkmania was sprinkled as a heat-meltable powder by using a cascade shaker (manufactured by Europort Co., Ltd.), and then excess resin powder was shaken off to obtain a transfer medium.

### 3. Evaluation

### 3.1. Color Developing Properties

Dyed objects according to Examples and Comparative Examples were evaluated for color developing properties. Specifically, an OD value of a recorded portion of each color of each dyed object obtained as described above was measured using a spectral densitometer FD-7 (manufactured by Konica Minolta, Inc.). The ratio of the OD value of each of the other Examples and Comparative Examples to the OD value of the recorded portion of the dyed object of Comparative Example 1 as a basis was determined and evaluated according to the following evaluation criteria. It can be said that the larger this ratio, the more excellent color developing properties.

### Evaluation Criteria

A: The OD value is 120% or more of that of the comparative example as a basis.
B: The OD value is greater than 100% and less than 120% of that of the comparative example as a basis.
C: The OD value is 100% or less of that of the comparative example as a basis.

### 3.2. Image Blurring

An ink jet printer (product name: PX-G930, manufactured by Seiko Epson Corporation) was filled with the ink compositions, and recording was performed on a recording medium (manufactured by Inkmania, a print film for DTF). Specifically, a solid pattern that could be recorded with a duty of 100% at resolutions of 720 dpi horizontally and 720 dpi vertically was produced and used. The solid pattern of the transfer object was visually observed and evaluated according to the following evaluation criteria.

### Evaluation Criteria

A: No abnormality
B: Disturbance in image quality is slightly observed.
C: Disturbance in image quality is clearly observed.

### 3.3. Transferability

When the image of each transfer medium was transferred to the recording medium, the condition after release from the film was visually observed to evaluate releasability.

### Evaluation Criteria

A: 100% of the printed image area has been transferred.
B: 80% or more and less than 100% of the printed image area has been transferred.
C: Less than 80% of the printed image area has been transferred.

### 3.4. Texture

The dyed objects according to Examples and Comparative Examples were evaluated for texture. Specifically, the texture of each transfer object was evaluated by a specific evaluator according to the following evaluation criteria. The evaluation results mean that C, B, and A is an ascending order of excellence in texture.

### Evaluation Criteria

A: The transfer object is soft and has no stiff texture.
B: The transfer object is rather hard and has a slightly stiff texture.
C: The transfer object has a pronounced stiff texture.

### 3.5. Dry Rubbing Fastness

The dyed objects according to Examples and Comparative Examples were evaluated for dry rubbing fastness. Specifically, each dyed object was left to stand at 25° C. for 1 hour after production, and the recorded surface of the dyed object was rubbed 20 times with a cotton cloth under a load of 200 g using a Gakushin type rubbing fastness tester AB-301 (manufactured by Tester Sangyo Co., Ltd.). The presence or absence of peeling of the recorded surface and ink transfer to the cotton cloth was visually observed and evaluated according to the following evaluation criteria. It can be said that the less color transfer and peeling, the more excellent abrasion resistance, and it can be said that the more excellent dry rubbing fastness, the more excellent fastness.

### Evaluation Criteria

A: Neither color transfer nor peeling is observed.
B: Color transfer and peeling are slightly observed.
C: Color transfer and peeling are clearly observed.

### 3.6. Wet Rubbing Fastness

The dyed objects according to Examples and Comparative Examples were evaluated for wet rubbing fastness. Specifically, each dyed object was left to stand at 25° C. for 1 hour after production, and the recorded surface of the dyed object was rubbed 20 times with a cotton cloth wetted by immersion in pure water under a load of 200 g using a Gakushin type rubbing fastness tester AB-301 (manufactured by Tester Sangyo Co., Ltd.). The presence or absence of peeling of the recorded surface and ink transfer to the cotton cloth were visually observed and evaluated according to the following evaluation criteria. It can be said that the less color transfer and peeling, the more excellent wet rubbing fastness, and it can be said that the more excellent abrasion resistance, the more excellent fastness.

### Evaluation Criteria

A: Neither color transfer nor peeling is observed.
B: Color transfer and peeling are slightly observed.
C: Color transfer and peeling are clearly observed.

### 3.7. Washing Fastness

The dyed objects according to Examples and Comparative Examples were evaluated for washing fastness. Specifically, a washing fastness test (ISO 105 C10 (B2)) was conducted, and evaluation was performed according to the following evaluation criteria.

### Evaluation Criteria

A: Washing fastness is Grade 3 or higher.
B: Washing fastness is Grade 2 or higher and lower than Grade 3.
C: Washing fastness is lower than Grade 2.

### 3.8. Clogging Properties

An ink jet printer (product name: PX-G930, manufactured by Seiko Epson Corporation) was filled with the adhesive ink, and the ink jet printer was left to stand for one month with its cap opened. Subsequently, cleaning was performed three times, and the number of non-ejecting nozzles was determined. Clogging properties were evaluated according to the following evaluation criteria. In Comparative Example 2, since the resin powder was used instead of the adhesive ink, clogging properties were not evaluated.

### Evaluation Criteria

A: No non-ejecting nozzles
B: 1 to 5 non-ejecting nozzles
B−: 6 to 20 non-ejecting nozzles
C: 21 or more non-ejecting nozzles

### 3.9. Apparatus Size

The size of the installation area of the printer and an automatic apparatus for sprinkling powder and the size of the installation area of the printer and a printing apparatus for ejecting the adhesive ink were compared. The size of the installation area of the printer and the printing apparatus for ejecting the adhesive ink was compared to the size of the installation area of the printer and the automatic apparatus for sprinkling powder in Comparative Example 1. When an operation to sprinkle powder is performed manually without using the automatic apparatus, a work space required for the powder sprinkling work is included in the installation area.

### Evaluation Criteria

A: The size of the installation area is less than 50%.
B: The size of the installation area is 50% or more and less than 100%.
C: The size of the installation area is 100% or more.

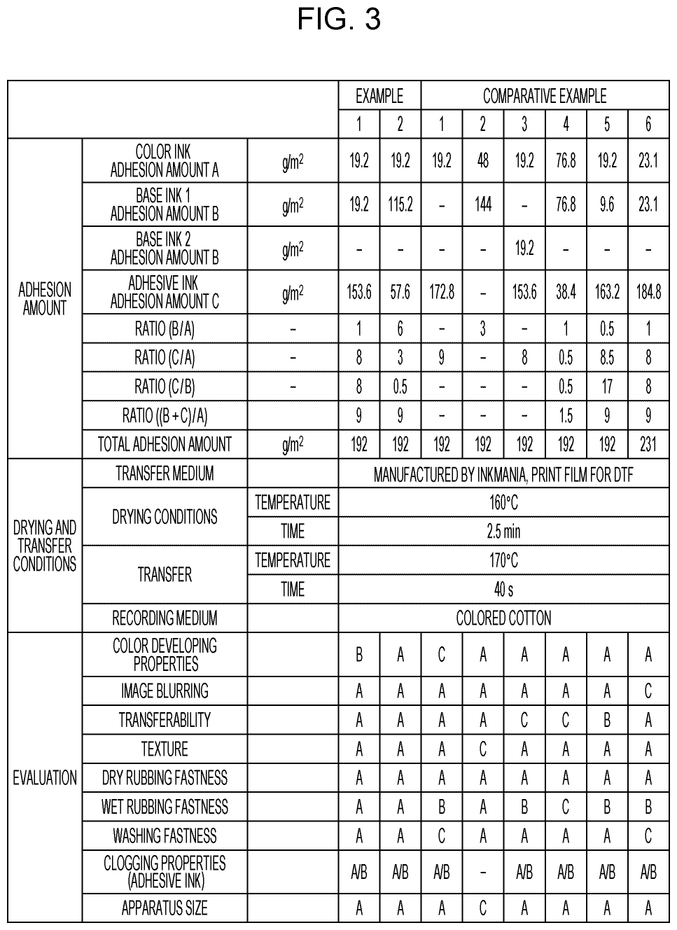

FIG. 3 is a table showing the inks and the evaluation results. As can be seen from FIG. 3, by executing recording with the predetermined adhesion amounts, blurring can be inhibited, and color developing properties, transferability, rubbing fastness, and washing fastness are excellent.

What is claimed is:

1. A method for producing a transfer medium, the method comprising:
ejecting a color ink by an ink jet method to form a first layer on a transfer medium having a release layer;
ejecting a base ink by an ink jet method to form a second layer so as to be overlaid on the first layer; and
ejecting an adhesive ink by an ink jet method to form a third layer so as to be overlaid on the second layer, wherein
the adhesive ink contains a resin and water,
the base ink contains a base pigment, a resin, and water,
an adhesion amount C of the adhesive ink is equal to or larger than an adhesion amount A of the color ink,
an adhesion amount B of the base ink is equal to or larger than the adhesion amount A of the color ink, and
a total adhesion amount of the color ink, the base ink, and the adhesive ink is 230 g/m² or less.

2. The method for producing a transfer medium according to claim 1, wherein a ratio (C/B) of the adhesion amount C of the adhesive ink to the adhesion amount B of the base ink is 0.3 to 10.

3. The method for producing a transfer medium according to claim 1, wherein a ratio (B/A) of the adhesion amount B of the base ink to the adhesion amount A of the color ink is 1.0 to 8.0.

4. The method for producing a transfer medium according to claim 1, wherein a ratio (C/A) of the adhesion amount C of the adhesive ink to the adhesion amount A of the color ink is 1.0 to 10.

5. The method for producing a transfer medium according to claim 1, wherein a ratio ((B+C)/A) of a total adhesion amount (B+C) of the base ink and the adhesive ink to the adhesion amount A of the color ink is 2.0 to 14.

6. The method for producing a transfer medium according to claim 1, wherein the adhesion amount B of the base ink is 0.6 g/m² or more.

7. The method for producing a transfer medium according to claim 1, wherein a solid content of the base pigment is 5.0 to 15% by mass with respect to a total amount of the base ink.

8. The method for producing a transfer medium according to claim 1, wherein a solid content of the resin contained in the base ink is 5 to 15% by mass with respect to a total amount of the base ink.

9. The method for producing a transfer medium according to claim 1, wherein a solid content of the resin contained in the adhesive ink is 10 to 20% by mass with respect to a total amount of the adhesive ink.
